(19) United States
(12) Patent Application Publication
(10) Pub. No.: US 2003/0120699 A1
(43) Pub. Date: Jun. 26, 2003

(54) Variable synchronicity between duplicate transactions

(75) Inventors: David G. Hostetter, Superior, CO (US); Michael Steven Milillo, Louisville, CO (US); Jennifer Johnson, Boulder, CO (US); Christopher J. West, Erie, CO (US)

Correspondence Address: Wayne P. Bailey, Storage Technology Corporation, One StorageTek Drive, Louisville, CO, 80028-4309, US

(73) Assignee: Storage Technology Corporation

(21) Appl. No.: 10/026,547

(22) Filed: Dec. 24, 2001

(51) Int. Cl. G06F 9/00

(52) U.S. Cl. 709/101

(57) ABSTRACT

A data processing system, computer program product, and data processing system for providing an adjustable level of synchronicity between duplicated transactions is disclosed. An acceptable level of lag between transactions is specified. Duplicated transactions performed at redundant systems are allowed to lag behind the corresponding transactions at the primary system by the specified amount of lag. Lag may be measured in terms of number of transactions, an amount of data, amount of time, or using any other suitable metric.

### 1. FIELD OF THE INVENTION

The present invention relates generally to the synchronization of transactions in a data processing system, and more particularly to an I/O and storage replication solution that balances performance with synchronicity.

### 2. BACKGROUND OF THE INVENTION

The ability to duplicate transactions is critical in fault-tolerant computing. If a first system is made to perform a series of transactions culminating in a set of results and a second, redundant system is made to perform the identical transactions, the results generated by either of the systems may be used if one of the systems fails. To ensure that the results of one device are interchangeable with the results of a redundant device, it is important the devices be in synchronization. In other words, it is undesirable for one device to lag far behind another device in the completion of transactions.

In a fully-synchronous environment, each transaction is completely duplicated in all of the systems before any other transaction is allowed to be processed. This scheme has been used before in conjunction with peer-to-peer remote copy (PPRC). PPRC is a storage scheme whereby write commands received by a first storage system are relayed by that first storage system to a second storage system to produce a duplicate copy of the contents of the first storage system.

Although this synchronicity is desirable from a fault-tolerance standpoint, it can result in significant performance degradation. This is particularly true if the devices involved are located in positions that are geographically distant from one another, since the communication necessary to relay commands and to transmit confirmations that transactions have been completed can incur significant delays. Thus, what is needed is a way to duplicate transactions that preserve some level of synchronicity, while delivering enhanced performance.

### SUMMARY OF THE INVENTION

The present invention provides a method, computer program product, and data processing system for providing an adjustable level of synchronicity between duplicated transactions. An acceptable level of lag between transactions is specified. Duplicated transactions performed at redundant systems are allowed to lag behind the corresponding transactions at the primary system by the specified amount of lag. Lag may be measured in terms of number of transactions, an amount of data, amount of time, or using any other suitable metric.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a data processing system in which the present invention may be implemented;

FIG. 2 is a block diagram of a storage system in accordance with a preferred embodiment of the present invention;

FIG. 3 is a diagram depicting synchronous peer-to-peer remote copy (PPRC) as it exists to the art;

FIG. 4 is a flowchart representation of a process of synchronous PPRC as it is known in the art;

FIG. 5 is a diagram depicting a PPRC system in accordance with a preferred embodiment of the present invention;

FIG. 6 is a flowchart representation of a process of performing peer-to-peer remote copying with a measured degree of synchronicity given up, in accordance with a preferred embodiment of the present invention;

FIG. 7 is a diagram depicting an alternative embodiment of the present invention in which time is used to measure the level of synchronicity; and

FIG. 8 is a diagram depicting an alternative embodiment of the present invention in which the degree of synchronicity that it given up is proportional to the number of devices with outstanding write commands to be processed.

### DETAILED DESCRIPTION OF THE PREFERRED EMBODIMENT

With reference now to the figures and with reference in particular to FIG. 1, a diagram of a data processing system is depicted in which the present invention may be implemented. Data processing system 100 includes a host 102, which has a connection to network 104. Data may be stored by host 102 in primary storage system 106. Data written to primary storage system 106 is copied to secondary system 108 in these examples. The copy process is used to create a copy of the data in primary storage system 106 in secondary storage system 108. In these examples, the copy process is a peer-to-peer remote copy (PPRC) mechanism.

In these examples, host 102 may take various forms, such as a server on a network, a Web server on the Internet, or a mainframe computer. Primary storage system 106 and secondary storage system 108 are disk systems in these examples. Specifically, primary storage system 106 and secondary storage system 108 are each set up as shared virtual arrays to increase the flexibility and manageability of data stored within these systems. Network 104 may take various forms, such as, for example, a local area network (LAN), a wide area network (WAN), the Internet, or an intranet. Network 104 contains various links, such as, for example, fiber optic links, packet switched communication links, enterprise systems connection (ESCON) fibers, small computer system interface (SCSI) cable, and wireless communication links. FIG. 1 is intended as an example of a data processing system in which the present invention may be implemented and not as an architectural limitation to the present invention. For example, host 102 and primary storage system 106 may be connected directly while primary storage system 106 and secondary storage system 108 may be connected by a LAN or WAN. Further, primary storage system 106 and secondary storage system 108 may be connected to each other by a direct connection 110, rather than through network 104.

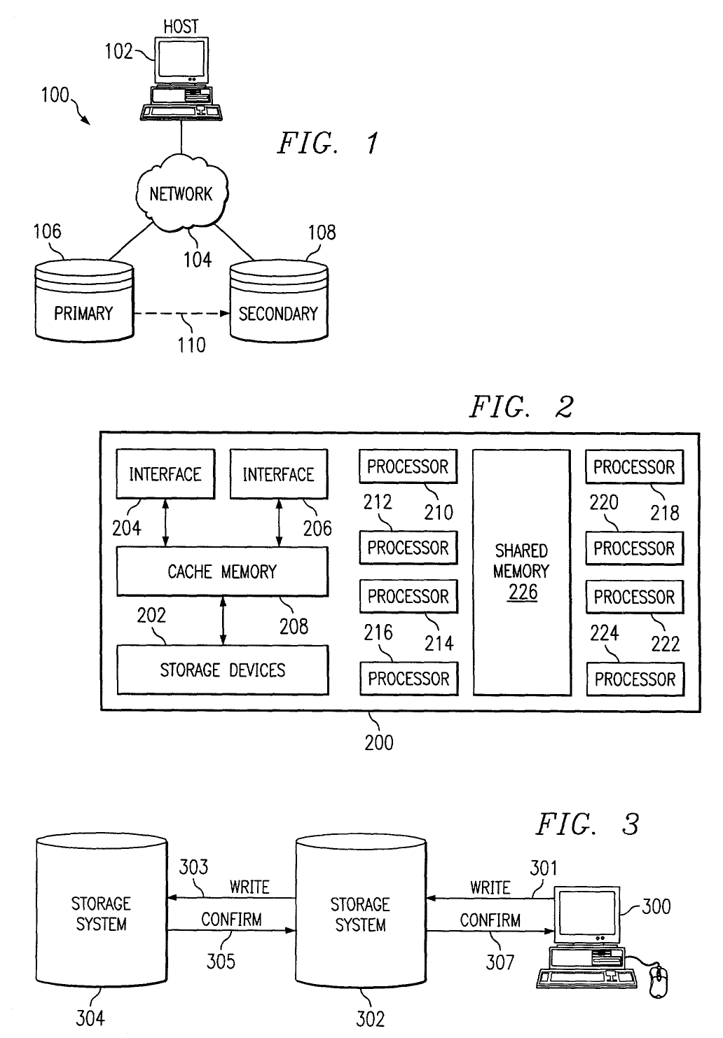

Turning next to FIG. 2, a block diagram of a storage system is depicted in accordance with a preferred embodiment of the present invention. Storage system 200 may be used to implement primary storage system 106 or secondary storage system 108 in FIG. 1. As illustrated in FIG. 2, storage system 200 includes storage devices 202, interface 204, interface 206, cache memory 208, processors 210-224, and shared memory 226.

Interfaces 204 and 206 in storage system 200 provide a communication gateway through which communication between a data processing system and storage system 200 may occur. In this example, interfaces 204 and 206 may be implemented using a number of different mechanisms, such as ESCON cards, SCSI cards, fiber channel interfaces, modems, network interfaces, or a network hub. Although the depicted example illustrates the use of two interface units, any number of interface cards may be used depending on the implementation.

In this example, storage system 200 is a shared virtual array. Storage system 200 is a virtual storage system in that each physical storage device in storage system 200 may be represented to a data processing system, such as host 100 in FIG. 1, as a number of virtual devices. In this example, storage devices 202 are a set of disk drives set up as a redundant array of inexpensive disks (RAID) system. Of course, other storage devices may be used other than disk drives. For example, optical drives may be used within storage devices 202. Further, a mixture of different device types may be used, such as, disk drives and tape drives.

Data being transferred between interfaces 204 and 206 and storage devices 202 are temporarily placed into cache memory 208. Additionally, cache memory 208 may be accessed by processors 210-224, which are used to handle reading and writing data for storage devices 202. Shared memory 226 is used by processors 210-224 to handle and manage the reading and writing of data to storage devices 202. In this example, processors 210-224 are used to write data addressed using a virtual volume to the physical storage devices. For example, a block of data, such as a track in a virtual volume, may be received by interface 204 for storage. A track is a storage channel on disk, tape, or other storage media. On disks, tracks are concentric circles (hard and floppy disks) or spirals (CDs and videodiscs). On tapes, tracks are arranged in parallel lines. The format of a track is determined by the specific drive in which the track is used. On magnetic devices, bits are used to form tracks and are recorded as reversals of polarity in the magnetic surface. On CDs, the bits are recorded as physical pits under a clear, protective layer. This data is placed in cache memory 208. Processors 210-224 will write the track of data for this volume into a corresponding virtual volume set up using storage devices 202.

The illustration of storage system 200 in FIG. 2 is not intended to imply architectural limitations of the present invention. Storage system 200 may be implemented using any one of a number of available storage systems. For example, a Shared Virtual Array (9393-6) system available from Storage Technology Corporation located in Louisville, Colo. may be used to implement the present invention.

FIG. 3 is a diagram depicting synchronous peer-to-peer remote copy (PPRC) as it exists to the art. A host computer 300 issues a write command 301 to a storage system 302. Storage system 302 relays a copy of the write command (303) to peer storage system 304. This communication with peer storage system 304 may take place, for instance, through a network, or through any other suitable communications medium (e.g., direct cable connection, wireless or infrared link, etc.). When storage system 304 has completed the write command, storage system 304 sends a confirmation message 305 to storage system 302. Storage system 302 then issues its own confirmation message 307 to host computer 300. In this way, host computer 300 is assured that the data is written to both storage system 302 and storage system 304. Generally speaking, host computer 300 will not issue any more input/output commands to either storage system 302 or storage system 304 until both storage systems are in synchronization. This is to ensure that host computer 300 does not observe any discrepancies between storage system 302 and storage system 304 when performing subsequent input/output operations.

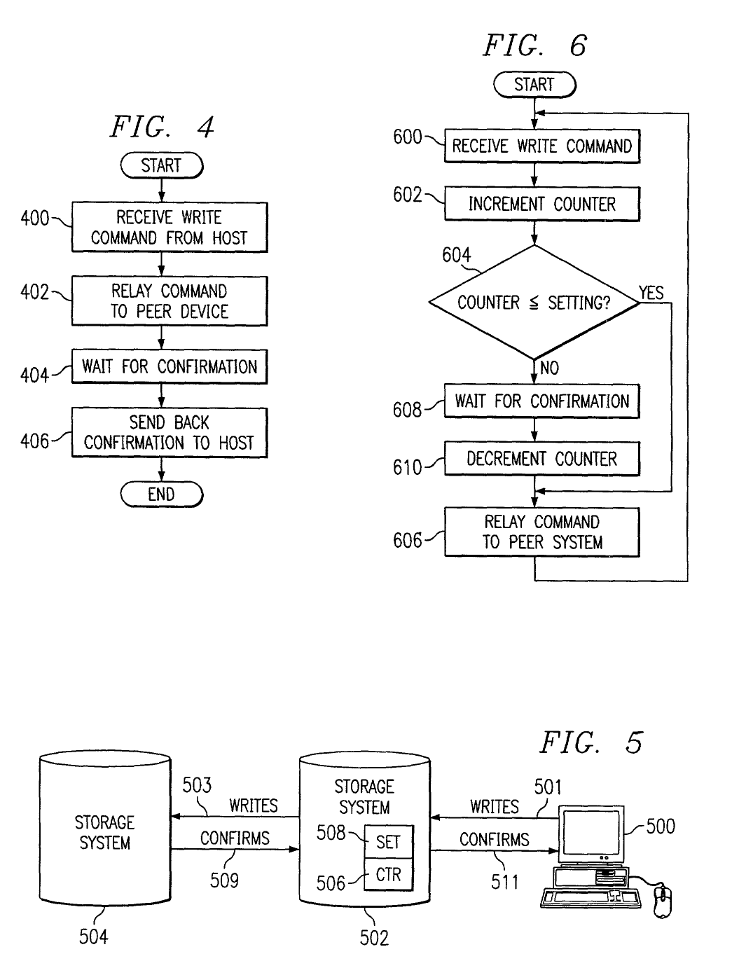

FIG. 4 is a flowchart representation of a process of synchronous PPRC as it is known in the art. The steps in the flowchart depicted in FIG. 4 are written with respect to storage system 302 in FIG. 3. First, the storage system receives a write command from a host computer, which it executes (step 400). After receiving the write command, but possibly while the write command is being executed, the storage system relays the command to a peer system (step 402). The storage system then waits for confirmation from the peer system that the write command has been completed at the peer system (step 404). Finally, once confirmation has been received, the storage system sends back a confirmation message to the host computer (step 406).

The prior art solution just discussed is very effective in keeping the two storage systems synchronized. This solution, however, has a major drawback in that the response time for input/output operations is undesirably long. The host computer must wait for both systems to complete their write operations before resuming input/output operations that it may have waiting to be processed. This problem gets worse if the two systems are geographically further apart from each other. As data synchronization and quick response time are both desirable design goals, the present invention is directed at striking a balance between these two goals by trading a measured amount of synchronicity for a faster response time.

A preferred embodiment of the present invention allows a user or administrator to select a degree of synchronicity desired. In other words, systems are allowed to be out of synchronization to a limited, pre-specified degree. For example, in the PPRC context depicted in FIG. 3, storage system 304 may be allowed to operate three write commands behind or four write commands behind or at whatever level of synchronicity is desired. One of ordinary skill in the art will recognize that synchronicity need not be measured in terms of a number of write commands, but may be measured in one of a myriad of different ways. Possible synchronicity measurements include, but are not limited to, an amount of data, period of time, a number of input/output transactions, a number of systems to which input/output commands have been submitted, and the like. One of ordinary skill in the art will also recognize that the processes described herein need not be performed with respect to storage systems, but may be performed with respect to any of a large number of computing entities including communication between software processes on a host machine, communication between software processes on multiple machines, communication between hardware devices in a network, and the like. A computing entity is simply any computer hardware, computer software, or a combination of computer hardware and computer software.

For the sake of continuity and clarity, however, the invention is described here in the context of the PPRC application through which the problem was originally revealed herein.

FIG. 5 is a diagram depicting a data processing system utilizing PPRC in accordance with a preferred embodiment of the present invention. Host computer 500 issues write commands 501 to storage system 502. Storage system 502 relays write commands 503 to storage system 504. Storage system 502 keeps track of the number of write commands that were relayed to storage system 504 by maintaining a counter 506. One of ordinary skill in the art will recognize that counter 506, although it is shown in conjunction with storage system 502, may be implemented within host computer 500, or any other appropriate computing system.

Storage system 502 compares counter 506 to synchronicity setting 508. Synchronicity setting 508 represents the number of outstanding write commands that can be issued to storage system 504 at any one time. Thus, if synchronicity setting 508 is set to three, then storage system 504 is allowed to lag behind storage system 502 in synchronization by three write commands. Once the number of write commands relayed to storage system 504 from storage system 502, reaches the value of synchronicity setting 508, storage system 502 will relay no more write commands to storage system 504 until storage system 504 sends a confirmation 509 to storage system 502 to indicate that one of the outstanding write commands has been completed.

Storage system 502 also sends confirmation messages 511 to host computer 500. Confirmation messages 511 inform host computer 500 that further input/output commands may be submitted to storage system 502. If the value in counter 506 is less than the value of synchronicity setting 508, storage system 502 will send a confirmation message to host computer 500 once a write command is completed by storage system 502. If, on the other hand, counter 506 contains a value that is equal to synchronicity setting 508, storage system 502 will not send a confirmation message to host computer 500 until it receives a confirmation message from storage system 504. Thus, only a measured degree of synchronicity is given up in exchange for faster response time.

FIG. 6 is a flowchart representation of a process of performing peer-to-peer remote copying with a measured degree of synchronicity given up, in accordance with a preferred embodiment of the present invention. The steps in the flowchart contained in FIG. 6 are written from the perspective of storage system 502 in FIG. 5, although one of ordinary skill in the art will recognize that these steps may be performed by any appropriate computing device within the data processing system. First, a write command is received by a storage system (step 600). Next, a counter representing the number of outstanding write commands is incremented (step 602). If the value contained in the counter is less than or equal to a predefined synchronicity setting (step 604:yes), the write command is relayed to the peer system (step 606). If not (step 604:no), then the storage system must wait for confirmation from the peer system (step 608). After confirmation has been received, the counter is decremented (step 610), and the write command is relayed to the peer system (step 606). Finally, the process cycles to step 600 to begin again.

FIG. 7 is a diagram depicting an alternative embodiment of the present invention in which time is used to measure the level of synchronicity. Host computer 700 issues write command 701 to storage system 702. Storage system 702 includes a real time clock 704, a time stamp queue 706, and a time limit setting 708. Each time host computer 700 issues a write command to storage system 702 the time at which storage system 702 receives the command is read from real time clock 704 and written to time stamp queue 706. Thus, the head of time stamp queue 706 will reflect the receipt time of the earliest outstanding write command and the tail of time stamp queue 706 will reflect the receipt time of the latest issued write command.

Storage system 702 relays write command 709 to storage system 710. When storage system 710 completes a write command, it sends a confirmation message 711 to storage system 702. When storage system 702 receives confirmation message 711, storage system 702 removes the time stamp at the head of time stamp queue 706. Storage system 702 continuously monitors the head of time stamp queue 706, and when the time recorded at the head of time stamp queue 706 is earlier than the currently reflected value of real time clock 704 by an amount that exceeds limited setting 708, storage system 702 withholds sending confirmation messages 713 to host computer 700 until the difference between the value of real time clock 704 and the head of time stamp queue 706 is less than the value of limit setting 708. In this way, storage system 710 never lags storage system 702 by an amount of time exceeding limit setting 708.

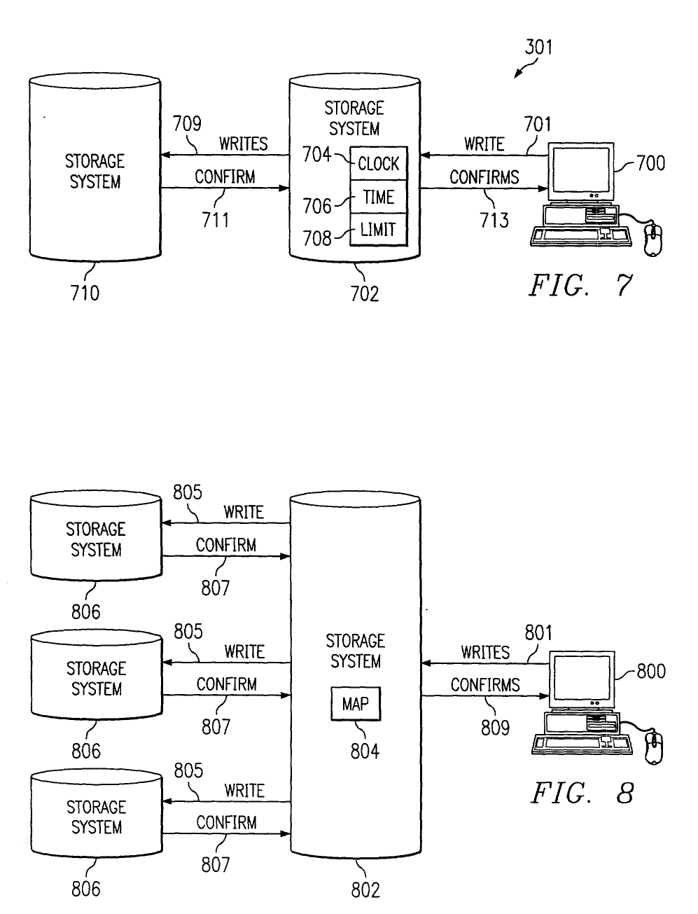

FIG. 8 is a diagram depicting an alternative embodiment of the present invention in which the degree of synchronicity that is given up is proportional to the number of storage systems with outstanding write commands to be processed. Host computer 800 issues write commands 801 to storage system 802. Storage system 802 is mirrored by storage systems 806 using a peer-to-peer copy scheme. Storage system 802 relays write commands 805 to storage systems 806 when write commands 801 are received from host computer 800. A storage system map 804 associated with storage system 802 keeps track of which of storage systems 806 have outstanding write commands that have not yet been completed. As storage systems 806 complete write commands 805, storage systems 806 individually send confirmation messages 807 to storage system 802 to signify that the write commands have been completed. As confirmation messages 807 are received by system 802, storage system map 804 is updated to reflect the completion of the write command on those of storage systems 806 for which the write commands have been completed. Storage system 802 abstains from sending confirmation message 809 to host computer 800 until a specified number of systems 806 complete the write commands relayed to them by storage system 802.

It is important to note that while the present invention has been described in the context of a fully functioning data processing system, those of ordinary skill in the art will appreciate that the processes of the present invention are capable of being distributed in the form of a computer readable medium of instructions or other functional descriptive material of various forms. The present invention applies equally regardless of the particular type of signal bearing media actually used to carry out the distribution. Examples of computer readable media include recordable-type media such a floppy disc, a hard disk drive, a RAM, CD-ROMs, and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for synchronizing transactions comprising:
executing a series of commands at a first computing entity; and
relaying the series of commands to a second computing entity such that the second computing entity lags behind the first computing entity by an amount of lag that is no greater than a specified synchronicity setting.

2. The method of claim 1, wherein the first computing entity is a computer peripheral.

3. The method of claim 2, wherein the computer peripheral is a storage system.

4. The method of claim 1, wherein the first computing entity is a computer.

5. The method of claim 1, wherein the first computing entity is a computer program.

6. The method of claim 1, wherein the amount of lag and the specified synchronicity setting are measured as numbers of commands executed.

7. The method of claim 1, wherein the amount of lag and the specified synchronicity setting are measured as amounts of time.

8. The method of claim 1, wherein the amount of lag and the specified synchronicity setting are measured as amounts of data.

9. The method of claim 1, wherein the amount of lag and the specified synchronicity setting are measured as numbers of devices with outstanding commands to execute.

10. The method of claim 1, wherein the second computing entity is a computer peripheral.

11. The method of claim 10, wherein the computer peripheral is a storage system.

12. The method of claim 1, wherein the second computing entity is a computer.

13. The method of claim 1, wherein the second computing entity is a computer program.

14. The method of claim 1, wherein the series of commands is for a peer-to-peer remote copy operation.

15. A computer program product in a computer-readable medium comprising functional descriptive data that, when executed by a computer, enables the computer to perform acts including:
executing a series of commands at a first computing entity; and
relaying the series of commands to a second computing entity such that the second computing entity lags behind the first computing entity by an amount of lag that is no greater than a specified synchronicity setting.

16. The computer program product of claim 15, wherein the first computing entity is a computer peripheral.

17. The computer program product of claim 16, wherein the computer peripheral is a storage system.

18. The computer program product of claim 15, wherein the first computing entity is the computer.

19. The computer program product of claim 15, wherein the first computing entity is a computer program.

20. The computer program product of claim 15, wherein the amount of lag and the specified synchronicity setting are measured as numbers of commands executed.

21. The computer program product of claim 16, wherein the amount of lag and the specified synchronicity setting are measured as amounts of time.

22. The computer program product of claim 15, wherein the amount of lag and the specified synchronicity setting are measured as amounts of data.

23. The computer program product of claim 15, wherein the amount of lag and the specified synchronicity setting are measured as numbers of devices with outstanding commands to execute.

24. The computer program product of claim 15, wherein the second computing entity is a computer peripheral.

25. The computer program product of claim 24, wherein the computer peripheral is a storage system.

26. The computer program product of claim 15, wherein the second computing entity is a computer.

27. The computer program product of claim 15, wherein the second computing entity is a computer program.

28. The computer program product of claim 15, wherein the series of commands is for a peer-to-peer remote copy operation.

29. A computer program product in a computer-readable medium comprising functional descriptive data that, when executed by a computer, enables the computer to perform acts including:
copying extents of data from a host to a first storage system pursuant to instructions from the host;
relaying the instructions to a second storage system such that the second storage system lags behind the first storage system in copying the extents of data by an amount of lag that is no greater than a specified synchronicity setting.

30. The computer program product of claim 29, wherein the amount of lag and the specified synchronicity setting are measured as numbers of instructions executed.

31. The computer program product of claim 29, wherein the amount of lag and the specified synchronicity setting are measured as amounts of time.

32. The computer program product of claim 29, wherein the amount of lag and the specified synchronicity setting are measured as amounts of data.

33. A data processing system comprising:
a processing unit including at least one processor; memory; and
a set of instructions within the memory,
wherein the processing unit executes the set of instructions to perform acts including:
executing a series of commands; and
relaying the series of commands to a second computing entity such that the second computing entity lags behind the data processing system by an amount of lag that is no greater than a specified synchronicity setting.

34. The data processing system of claim 33, wherein the amount of lag and the specified synchronicity setting are measured as numbers of commands executed.

35. The data processing system of claim 33, wherein the amount of lag and the specified synchronicity setting are measured as amounts of time.

36. The data processing system of claim 33, wherein the amount of lag and the specified synchronicity setting are measured as amounts of data.

37. The data processing system of claim 33, wherein the amount of lag and the specified synchronicity setting are measured as numbers of devices with outstanding commands to execute.

38. The data processing system of claim 33, wherein the second computing entity is a computer peripheral.

39. The data processing system of claim 38, wherein the computer peripheral is a storage system.

40. The data processing system of claim 33, wherein the second computing entity is a computer.

41. The data processing system of claim 33, wherein the second computing entity is a computer program.

42. The data processing system of claim 33, wherein the series of commands is for a peer-to-peer remote copy operation.
